(19) United States
(12) Patent Application Publication
(10) Pub. No.: US 2009/0112672 A1
(43) Pub. Date: Apr. 30, 2009

(54) Method and Arrangement for Optimized Maintenance of Components

(76) Inventors: Hartmut Flämig, Stutensee (DE); Herbert Grieb, Malsch (DE); Holger Rachut, Karlsruhe (DE)

Correspondence Address: Siemens Corporation;Intellectual Property Department, 170 Wood Avenue South, Iselin, NJ, 08830, US

(21) Appl. No.: 11/922,582

(22) PCT Filed: Jun. 30, 2005
(86) PCT No.: PCT/US05/23086

§ 371 Date: Dec. 18, 2007

(51) Int. Cl. G06Q 10/00

(52) U.S. Cl. 705/8; 705/400

(57) ABSTRACT

A method for optimizing the availability of a technical object, comprises the steps of providing a serviceable technical object; defining a service plan; defining a setpoint availability; maintaining the serviceable technical object according to the service plan; determining the actual availability of the serviceable technical object; and automatically adjusting the service plan according to a difference between the setpoint availability and the actual availability.

### TECHNICAL FIELD

The present application relates to a method and an arrangement for optimized maintenance of devices providing for increased and predictable availability of the device.

### BACKGROUND OF THE INVENTION

Availability of a technical device, in particular, in the context of large systems such as automation systems, assembly lines, etc. is one of the most important aspects with respect to costs and efficiency of the respective system. Availability, thus, defines the time a certain technical device is operable within its specification. Any technical system consisting of a plurality of technical devices including parts that are subject to wear and tear will fail at some time if the system is not properly maintained. Thus, each technical device or component often has a predictable operating time, also often expressed as a mean time between failure (MTBF). This operating time depends on the complexity of the system or component and also the required maintenance. If properly maintained the MTBF and, thus, the availability of the respective system or device can be increased. Even if the MTBF is known for single components of a complex system, the interaction between components and external conditions may influence the MTBF positively or negatively. Thus, a user of a complex system faces the problem to determine the connection between a maintenance activity of the single components and the effect that this maintenance has on the overall availability of the system. For example, a user would like to know by which degree the availability of a device is increased if, e.g., the lubricating interval for a valve of the system are shortened or enlarged. The result of such influencing factors is not easily obtainable as many other factors might be significant. For the user it is also important to compare the financial costs of the measurement with the benefit received to evaluate any economic utility/cost effectiveness of the measurement.

### SUMMARY OF THE INVENTION

Therefore, it is an object of the present application to provide for a method and arrangement which properly evaluates and controls the availability of a technical system or technical device.

A method for optimizing the availability of a technical object, comprises the steps of providing a serviceable technical object; defining a service plan; defining a setpoint availability; maintaining the serviceable technical object according to the service plan; determining the actual availability of the serviceable technical object; and automatically adjusting the service plan according to a difference between the setpoint availability and the actual availability.

The step of determining the actual availability of the serviceable technical object can be performed manually by a service personnel. The step of determining the actual availability of the serviceable technical object can also be performed automatically by evaluating at least one sensor value which determines a parameter of the serviceable technical object. The service plan may include a maintenance schedule including, at least one service interval. The service plan may include a task list. The step of adjusting the service plan may include the step of increasing or decreasing the service interval. The step of adjusting the service plan may also include the step of adding or modifying a task. The method steps can be performed for a plurality of serviceable technical objects with a plurality of setpoint availabilities for each object and a plurality of actual availabilities for each object, and the method may comprise the steps of determining a resulting availability from the plurality of actual availabilities; and adjusting each service plan according to each actual availability and according to the resulting availability. Each serviceable technical object can be of the same or similar type.

A system for optimizing the availability of a technical object, comprises a serviceable technical object; means for defining a service plan; means for defining a setpoint availability; means for maintaining the serviceable technical object according to the service plan; means for determining the actual availability of the serviceable technical object; and means for automatically adjusting the service plan according to a difference between the setpoint availability and the actual availability.

A service personnel may determine the actual availability of the serviceable technical object. The system may comprise at least one sensor value for determining a parameter of the serviceable technical object which relates to the availability of the object. The service plan may include a maintenance schedule including at least one service interval. The service plan may also include a task list. The means for adjusting the service plan may increase or decrease the service interval. The means for adjusting the service plan may add or modify a task of the task list. The system may comprise a plurality of serviceable technical objects with a plurality of setpoint availabilities for each object and a plurality of actual availabilities for each object, and may further comprise means for determining a resulting availability from the plurality of actual availabilities, wherein each service plan is adjusted according to each actual availability and according to the resulting availability. Each serviceable technical object can be of the same or similar type.

A method for optimizing the availability of a technical system including a plurality of serviceable technical objects, comprises the steps of defining a service plan for each serviceable technical object; defining a setpoint availability for each serviceable technical object; maintaining each serviceable technical object according to each service plan; determining each actual availability of each serviceable technical object; determining a resulting availability from all determined actual availabilities; and automatically adjusting the service plan according to a difference between the setpoint availability and the actual availability and according to the resulting availability.

Each service plan may include a maintenance schedule including at least one service interval. The service plan may also include a task list. The step of adjusting the service plan may include the step of increasing or decreasing the service interval. The step of adjusting the service plan may include the step of adding or modifying a task. Each serviceable technical object can be of the same or similar type.

### BRIEF DESCRIPTION OF THE DRAWINGS

FIG. 1 shows a first exemplary embodiment according to the present invention;

FIG. 2 shows a second exemplary embodiment according to the present invention;

FIG. 3 shows a third exemplary embodiment according to the present invention;

FIG. 4 shows a fourth exemplary embodiment according to the present invention; and

FIG. 5 is a set of characteristic curves showing the effect of an arrangement on the availability of a system as shown in FIG. 4.

### DETAILED DESCRIPTION OF THE PREFERRED EMBODIMENTS

Prior art systems do not provide for any means to control and evaluate the availability of a system besides recommending to schedule maintenance of the devices/components of a system according to the manufacturers specification. The effect of maintenance service on the system is today usually unknown. Usually, an operator might merely know the overall downtime of a system, however, the influence of additional maintenance service on the availability of the system is not easily determinable. An operator might define and determine certain maintenance characteristics to evaluate cost effects of the overall maintenance. These characteristics can be the number of unscheduled downtimes, the number and duration of services performed, the productivity per defined interval, etc. However, as explained above these values are merely used to determine the profitability and not used to either improve or evaluate the availability of a system. Even if these numbers are intuitively used to change a maintenance schedule, there is no feedback and documentation about the effect and therefore such measurements are subject to a mere random success or failure. Thus, there is a lack of systematics and lack of consideration of complex interrelationships between the parts and components and no support to actively influence the performance of a system.

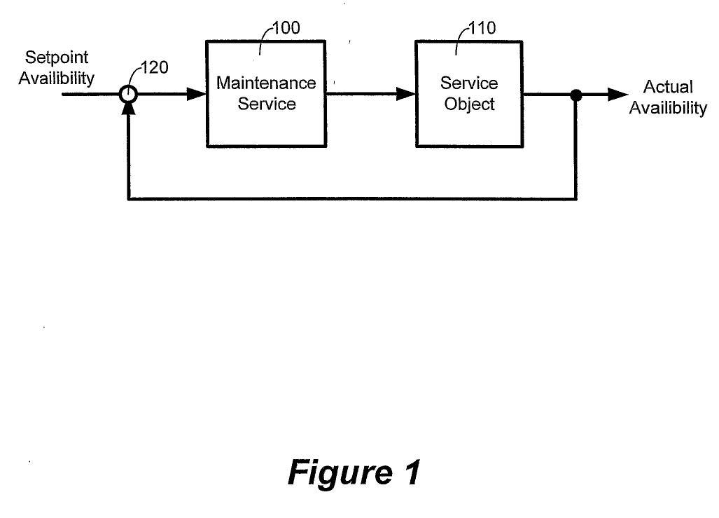

FIG. 1 shows a different approach which takes complex structures and interactions as well as any environmental condition or any other influence on the technical system into account. Even though FIG. 1 shows an equivalent circuit of an electronic control circuit/loop, the system described is a combination of a technical object, such as a technical device or component, and a maintenance service. The maintenance service can be an automated technical installation but in most cases will be a manually performed service by a respective service personnel. However, any combination of man delivered service and automated service is possible in this control loop. The user or operator of the system determines a setpoint value for the availability of the overall system. This value is fed to maintenance service module 100 which represents and controls a specific maintenance service to be provided to a service object 110. For example, the service object can be a gear box, a valve, a filter. The maintenance service to be performed can be, thus, a oil change for the gear box, a sealing replacement for the valve, a filter cleaning, respectively. Also, a device might require more than one specific maintenance service, such as exchange of a part plus cleaning plus lubrication, etc. These maintenance service steps are previously defined and the respective schedule and list of tasks is stored within the maintenance service module 100. The respective maintenance service performed with the respective maintenance interval and task results in an actual availability which is fed back to the maintenance service module via subtractor 120. If the availability is close to or equal than the requested availability, the system remains static or in other words, no changes of the existing maintenance schedule and task list will be performed.

However, if the availability is lower than the requested availability then the difference between actual availability and setpoint availability is forwarded to the maintenance service module. The maintenance service module then modifies the existing maintenance schedule and/or task list. For example, one or more specific intervals for specific tasks can be shortened, an additional measurement can be added to the list, etc. Some of these changes can be generated automatically whereas other changes can be performed manually. For example, an additional task to be performed due to special circumstances can be added annually whereas changes in maintenance intervals are computed automatically according to a predefined formula or data base.

If the availability is greater than the requested availability, the scheduled maintenance intervals can be enlarged, thus, reducing overall costs of the system. As explained above, every device, component, or part can have a specific pre-defined maintenance schedule and task list if necessary. Also, the system can provide for a specific or general cost analysis depending on the required availability. The cost analysis may take any increase or decrease in scheduled maintenance into account. In addition, information about the required manpower, time, material, and specific costs can be stored. Such information can be provided for by a respective manufacturer or vendor of the device, part, or component or it can be determined by the operator.

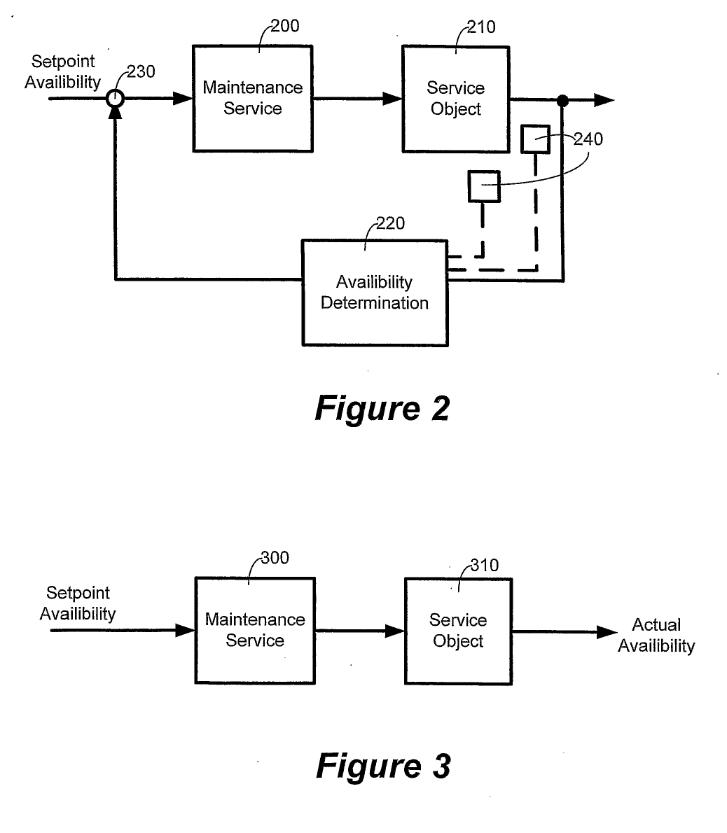

FIG. 2 shows another embodiment of the present invention. Again an equivalent control circuit is shown similar to FIG. 1. In this embodiment a specific unit 220 is provided to determine the availability of the respective service object 210, such as a technical device, component or part. Again, a maintenance service module 200 receives the difference between setpoint availability and actual availability and generates a specific customized maintenance service for the respective object 210. The method includes the step of comparing the setpoint availability and actual availability and depending on the difference certain service measurements are proposed until the setpoint and actual availability coincide. As the actual availability cannot be determined directly, unit 220 can determine the availability from external values according to a predefined formula. These values can be, for example, provided by specific sensors already provided within the service object 210 as shown by the feedback coupling or by additional sensors 240 as indicated by the dotted lines. The predefined formula for calculating the availability can be different for each device, component or part. The service provided by the maintenance module 200 is usually performed by service personnel such as technicians or service engineers. However, certain automatic services can be performed by automated service systems which are either integrated or added, for example, automatic lubrication, oil changes, etc.

The simplified control circuits do not show any specifically necessary control circuit details, such as a hysteresis or certain control thresholds. However, these can be implemented as necessary. FIG. 3 shows another embodiment according to the present invention which does not require a feedback loop. Thus, only maintenance service module 300 and service object 310 are shown. In this special case, the effect of each service measurement is exactly known and such information is provided for by the manufacturer/vendor. Thus, any change in a required availability can be directly translated into the required measurement. Therefore, no feedback loop is required. However, usually such an interrelationship is not known or other influential facts are present which render the information unreliable. Thus, in most cases, the availability determination unit 220 will be necessary to automatically determine and evaluate the service measurement.

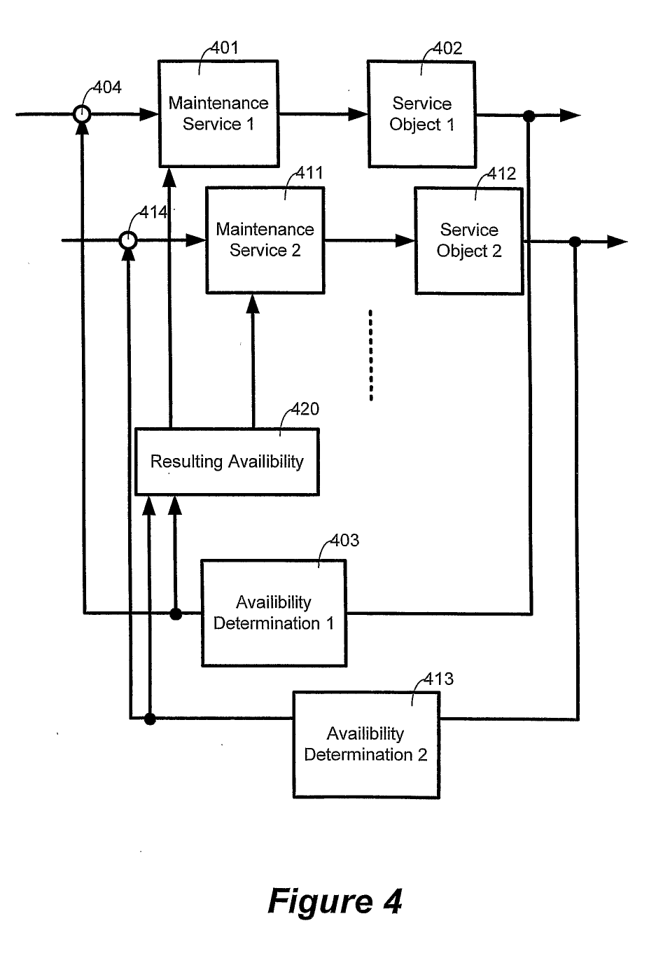

FIG. 4 shows a system in which a plurality of devices influence the availability of each device, component or part. In FIG. 2 two control circuits and their interrelationship are depicted. However, as the dotted line indicates, a plurality of such control circuits can be provided for a complex system. Thus, the first control circuit consists of maintenance service module 401 and service object 402 with the feedback loop including availability unit 403. Similarly, the second control circuit consists of maintenance service module 411 and service object 412 with the feedback loop including availability unit 413. Both circuits comprise subtractors 404 and 414, respectively. In addition a resulting availability unit 420 is provided which receives the respective availability values from each determination unit 403, 413. The resulting availability unit 420 evaluates the interrelationship and provides additional data to the respective maintenance service modules 401, 411.

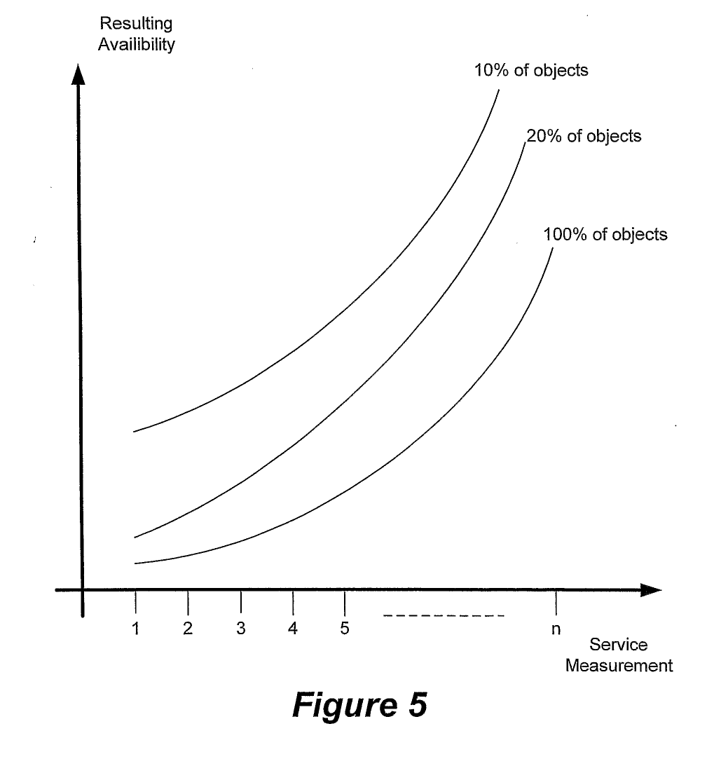

Preferably, the multiple object control circuit as shown in FIG. 4 comprises service objects 402, 412 of the same type. The resulting availability unit 420 calculates from the provided availability of each service object 402, 412 a overall resulting availability which is fed to each maintenance service unit 401, 411. The resulting availability is a set of characteristic curves as shown in FIG. 5. This set of characteristic curves contains data including information which maintenance measurement leads to which availability considering the percentage of serviced objects 402, 412. Each object 402, 412 may however, still have a customized setpoint availability. Also, the set of characteristic curves can provide further information, such as a bandwidth indicating a range of availability or an arithmetic or weighted mean value indicating an availability averaged over a number of devices. These values can be used to further adapt the maintenance schedule and task list of the maintenance service unit 401, 412.

In yet another embodiment, any type of control circuit as shown in FIGS. 1-3 can be combined to form an interrelated complex maintenance service system as shown in FIG. 4. As stated above, preferably, all service objects within an interrelated system are of the same type. However, if certain service objects influence certain serviceable functions of an object, a mixture of different types can also be implemented and will lead to beneficial results.

Instead of availability other maintenance parameters can be calculated with a system as described above. For example, the number of malfunctions/breakdowns, the required time for unscheduled repairs, etc. Also, costs can be directly assigned to the respective maintenance measurement. Thus, the control circuit can be controlled under pure cost considerations or a combination of cost and efficiency. Furthermore, specific costs, such as hourly rates of maintenance personnel, expendables, etc can be considered. For example, in case of high energy costs, a higher degree of efficiency is more valuable as in case of low energy costs. Thus, a very transparent maintenance can be provided for the operator of a complex system in which according to the respective desire targeted aspects such as costs or efficiency or a combination of it can be considered. The correct maintenance service will, thus, be implemented according to measurable criteria and will be automatically selected. Any random or intuitive measurement will be avoided.

The above described methods can be implemented as a stand alone device, for example on a personal computer, or can be integrated into an existing system such as an automation system or manufacturing execution system with complex control structures and asset management functions.

What is claimed is:

1. A method for optimizing the availability of a technical object comprising the steps of:
providing a serviceable technical object;
defining a service plan;
defining a setpoint availability;
maintaining the serviceable technical object according to the service plan;
determining the actual availability of the serviceable technical object;
automatically adjusting the service plan according to a difference between the setpoint availability and the actual availability.

2. The method according to claim 1, wherein the step of determining the actual availability of the serviceable technical object is performed manually by a service personnel.

3. The method according to claim 1, wherein the step of determining the actual availability of the serviceable technical object is performed automatically by evaluating at least one sensor value which determines a parameter of the serviceable technical object.

4. The method according to claim 1, wherein the service plan includes a maintenance schedule including at least one service interval.

5. The method according to claim 1, wherein the service plan includes a task list.

6. The method according to claim 4, wherein the step of adjusting the service plan includes the step of increasing or decreasing said service interval.

7. The method according to claim 5, wherein the step of adjusting the service plan includes the step of adding or modifying a task.

8. The method according to claim 1, wherein said method steps are performed for a plurality of serviceable technical objects with a plurality of setpoint availabilities for each object and a plurality of actual availabilities for each object, and wherein the method comprises the steps of:
determining a resulting availability from said plurality of actual availabilities; and
adjusting each service plan according to each actual availability and according to said resulting availability.

9. The method according to claim 8, wherein each serviceable technical object is of the same or similar type.

10. The method according to claim 1, further comprising the step of providing a cost analysis for providing said availability.

11. A system for optimizing the availability of a technical object comprising:
a serviceable technical object;
means for defining a service plan;
means for defining a setpoint availability;
means for maintaining the serviceable technical object according to the service plan;
means for determining the actual availability of the serviceable technical object;
means for automatically adjusting the service plan according to a difference between the setpoint availability and the actual availability.

12. The system according to claim 11, wherein a service personnel determines the actual availability of the serviceable technical object.

13. The system according to claim 11, comprising at least one sensor value for determining a parameter of the serviceable technical object which relates to the availability of said object.

14. The system according to claim 11, wherein the service plan includes a maintenance schedule including at least one service interval.

15. The system according to claim 11, wherein the service plan includes a task list.

16. The system according to claim 14, wherein the means for adjusting the service plan increase or decrease said service interval.

17. The system according to claim 15, wherein the means for adjusting the service plan add or modify a task of said task list.

18. The system according to claim 11, comprising a plurality of serviceable technical objects with a plurality of setpoint availabilities for each object and a plurality of actual availabilities for each object, and further comprising:
means for determining a resulting availability from said plurality of actual availabilities, wherein each service plan is adjusted according to each actual availability and according to said resulting availability.

19. The system according to claim 18, wherein each serviceable technical object is of the same or similar type.

20. The method according to claim 11, further comprising means for providing a cost analysis for providing said availability.

21. A method for optimizing the availability of a technical system including a plurality of serviceable technical objects, comprising the steps of:
defining a service plan for each serviceable technical object;
defining a setpoint availability for each serviceable technical object;
maintaining each serviceable technical object according to each service plan;
determining each actual availability of each serviceable technical object;
determining a resulting availability from all determined actual availabilities; and
automatically adjusting the service plan according to a difference between the setpoint availability and the actual availability and according to said resulting availability.

22. The method according to claim 21, wherein each service plan includes a maintenance schedule including at least one service interval.

23. The method according to claim 21, wherein the service plan includes a task list.

24. The method according to claim 22, wherein the step of adjusting the service plan includes the step of increasing or decreasing said service interval.

25. The method according to claim 23, wherein the step of adjusting the service plan includes the step of adding or modifying a task.

26. The method according to claim 21, wherein each serviceable technical object is of the same or similar type.

27. The method according to claim 21, further comprising the step of providing a cost analysis for providing said availability.
